(19) United States
(12) Patent Application Publication
(10) Pub. No.: US 2015/0070354 A1
(43) Pub. Date: Mar. 12, 2015

(54) COMPUTING DEVICE AND METHOD FOR RECONSTRUCTING CURVED SURFACE OF POINT CLOUD DATA

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN-YUAN WU, Shenzhen (CN); CHIH-KUANG CHANG, New Taipei (TW); PENG XIE, Shenzhen (CN)

(21) Appl. No.: 14/481,920

(22) Filed: Sep. 10, 2014

(30) Foreign Application Priority Data
Sep. 10, 2013 (CN) 201310407237.7

(51) Int. Cl. G06T 15/10

(52) U.S. Cl. CPC G06T 15/10
USPC 345/420

(57) ABSTRACT

In a method for reconstructing a curved surface of point cloud data using a computing device, point cloud data, a preset point distance is acquired and defined. A neighborhood point set for each point is calculated. The neighborhood point set of each point is fitted to be a plane, and a normal vector of the plane corresponding to each point is calculated. One or more singularity points in the neighborhood point set of each point is confirmed and corrected. A projection point set of each point is obtained by projecting the neighborhood points in the corrected neighborhood point set to the plane of each point. The projection point set of each point are meshed into triangles and the curved surface is reconstructed by integrating the plurality of triangles corresponding to the projection point set of each point.

### CROSS-REFERENCE TO RELATED APPLICATIONS

This application claims priority to Chinese Patent Application No. 201310407237.7 filed on Sep. 10, 2013, the contents of which are incorporated by reference herein.

### FIELD

Embodiments of the present disclosure relate to data processing technology, and particularly to a computing device and a method for reconstructing a curved surface of point cloud data using the computing device.

### BACKGROUND

During processes of a three-dimensional (3D) measurement and a reverse engineering, a curved surface reconstruction of point cloud data is an very important step. The curved surface reconstruction is generally based on a triangular meshing method. However, it is too complicated to process the point cloud data using a 3D triangular meshing processing. Therefore, the point cloud data is processed using a 2D triangular meshing processing firstly, and the meshed data is mapped to 3D coordinates. Although the above calculation method is simple, 3D features of point cloud data are not considered. This may cause that a reconstructed curved surface is not smooth enough and precision of reconstruction is not high enough.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of a computing device including a curved surface reconstruction system.

FIG. 2 is a diagrammatic view of an embodiment of meshing partial of point cloud data using a triangular meshing method.

FIG. 3 is a flowchart of one embodiment of a method of reconstructing a curved surface of point cloud data using the computing device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.” It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives. The term “comprising” means “including, but not necessarily limited to”; it specifically indicates open-ended inclusion or membership in a so-described combination, group, series and the like.

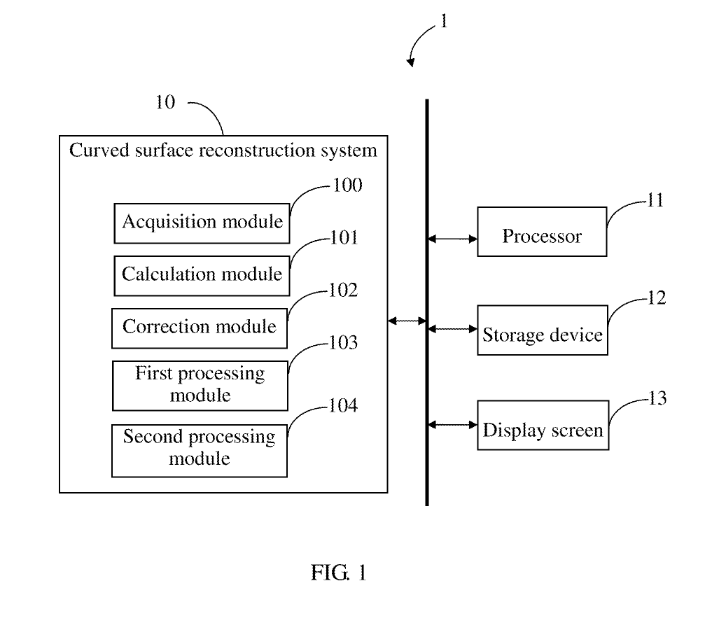

FIG. 1 is a block diagram of one embodiment of a computing device including a curved surface reconstruction system. The computing device 1 includes, but is not limited to, a curved surface reconstruction system 10, at least one processor 11, a storage system 12, and a display screen 13. The at least one processor 11 executes one or more computerized codes and other applications of the computing device 1 to provide functions of the curved surface reconstruction system 10. The storage system 12 can be an internal storage system, such as a random access memory (RAM) for temporary storage of information, and/or a read only memory (ROM) for permanent storage of information. The storage system 12 can also be an external storage system, such as an external hard disk, a storage card, or a data storage medium.

In one embodiment, the curved surface reconstruction system 10 includes, but is not limited to, an acquisition module 100, a calculation module 101, a correction module 102, a first processing module 103, and a second processing module 104. The modules 100-104 include computerized code in the form of one or more programs that are stored in the storage system 12. The computerized code includes instructions that are executed by the at least one processor 11 to provide functions of the curved surface reconstruction system 10.

The acquisition module 100 configures to acquire point cloud data of an object (for example, a product) which needs to construct a curved surface from the storage system 12. In one embodiment, the point cloud data can be acquired form other point cloud scanning device (not shown in FIG. 1). The acquisition module 100 further configures to define parameters related to reconstructing the curved surface. The parameters includes, but is not limited to, a preset point distance and a determination parameter (referred as “C”) of a singularity point. In the embodiment, the determination parameter “C” is a constant. For example, a value of the determination parameter “C” can be set to be 0.5 or 2. The parameters can be preset according to actual requirements for different objects. The singularity point is a point in the point cloud data which is far away from a curved surface of the point cloud, and it is resulted in wrong scanned point of the object or scanning point of an edge of the object.

The calculation module 101 configures to calculate a neighborhood point set for each point in the point cloud data according to the preset point distance. In one embodiment, a distance between each point and each neighborhood point in the neighborhood point set of the each point are less than or equal to the preset point distance. The calculation module 101 further configures to fit the neighborhood point set of each point to be a plane, and calculate a normal vector of the plane corresponding to each point;

In one embodiment, if a neighborhood point set of a point “Pᵢ” is represented as “Sᵢ”, and an equation of the barycentre of the point is

$$“ \overline{{P}_{i}} = \frac{{\sum }_{j ∈ Si} {P}_{j}}{\vert {S}_{i} \vert} ”$$

(A first formula), the barycentre should be on the plane fitted by the neighborhood point set. In the first formula, “Pⱼ” represents a neighborhood point in the neighborhood point set and “ P̅ᵢ̅” represents the barycentre of the point “Pᵢ”. In the embodiment, a predetermined covariance matrix is preset to be “C=[Pⱼ₁− P̅ᵢ̅. . . Pⱼₙ− P̅ᵢ̅].[Pⱼ₁− P̅ᵢ̅. . . Pⱼₙ− P̅ᵢ̅]^{T}, jn∈Sᵢ” (A second formula). The predetermined covariance matrix is a semi-definite symmetric matrix, and a minimum vector of the covariance matrix is referred to be the normal vector of the plane. That is, the normal vector of the point “Pᵢ” is determined. In other embodiments, the calculation module 101 can use other methods (for example, the least-square method) to fit the neighborhood point set of each point and calculate the normal vector of each point.

The correction module 102 configures to confirm one or more singularity points in the point cloud data according to the neighborhood point set of each point, the determination parameter, and the normal vector corresponding to each point, and further correct the one or more singularity points for the neighborhood point set of each point. In one embodiment, the correction module 102 first calculates an average distance between neighborhood points in the neighborhood point set for each point and the plane corresponding to each point using a third formula of

$$“ \overline{{D}_{i}} = \sqrt{{\sum }_{j ∈ {S}_{j}} {( {( {P}_{j} - \overline{{P}_{j}} )}^{T} {n}_{j} )}^{2}} ” .$$

In the third formula, “ D̅ᵢ̅” represents the average distance, and “nⱼ” represents the normal vector of each point.

After calculating the average distance for each point, the correction module 102 determines the singularity point according to an determination formula of “: ((Pᵢ− P̅ᵢ̅)^{T}nᵢ)>C* D̅ᵢ̅”. That is, if a distance between a point “i” and the plane is greater than a product of the determination parameter and the average distance between the neighborhood points corresponding to the point “i” and the plane corresponding to the point “i”, the correction module 102 determines that the point “i” is the singularity point.

In the embodiment, the correction module 102 corrects the one or more singularity points by replacing each singularity point using a project point projected by the singularity point on the plane corresponding to the singularity point.

The first processing module 103 configures to obtain a projection point set of each point by projecting neighborhood points in the corrected neighborhood point set of each point to the plane corresponding to each point. The first processing module 103 further meshes the projection point set of each point into a plurality of triangles according to a regular triangulation method. In the embodiment, the regular triangulation method is based on a Delaunay triangulation method and preset distance weight values.

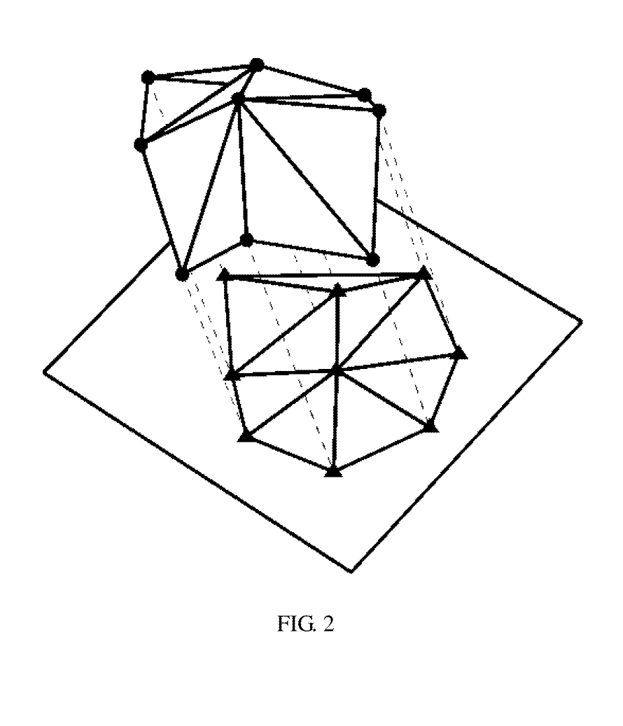

In one embodiment, the Delaunay triangulation method includes a lot of conditions, such as, no four points being on a circle, and no point being inside of any a triangle's circumcircle. During the Delaunay triangulation method, the circumcircle needs to be determined according to a distance difference between two points. In the embodiment, the regular triangulation method uses the preset distance weight values to redefine a distance between two points for determining the circumcircle. For example, a square of distance “d” between two pints is redefined as “d²=(x₁−x₂)²+(y₁−y₂)²−ω₁−ω₂”, and (x₁,Y₁) and (X₂, Y₂) are coordinates of two points and (0₁, W₂ are the preset distance weight values. As shown in FIG. 2, it is a schematic diagram of one embodiment of processing one projection point set of one point using a regular triangulation method.

The second processing module 104 configures to reconstruct the curved surface of the point cloud data by integrating the plurality of triangles corresponding to the projection point set of each point. In one embodiment, the second processing module 104 can connect triangles which have the same side with one another to obtain the curved surface. In one embodiment, the reconstructed curved surface can be displayed on the display screen 13.

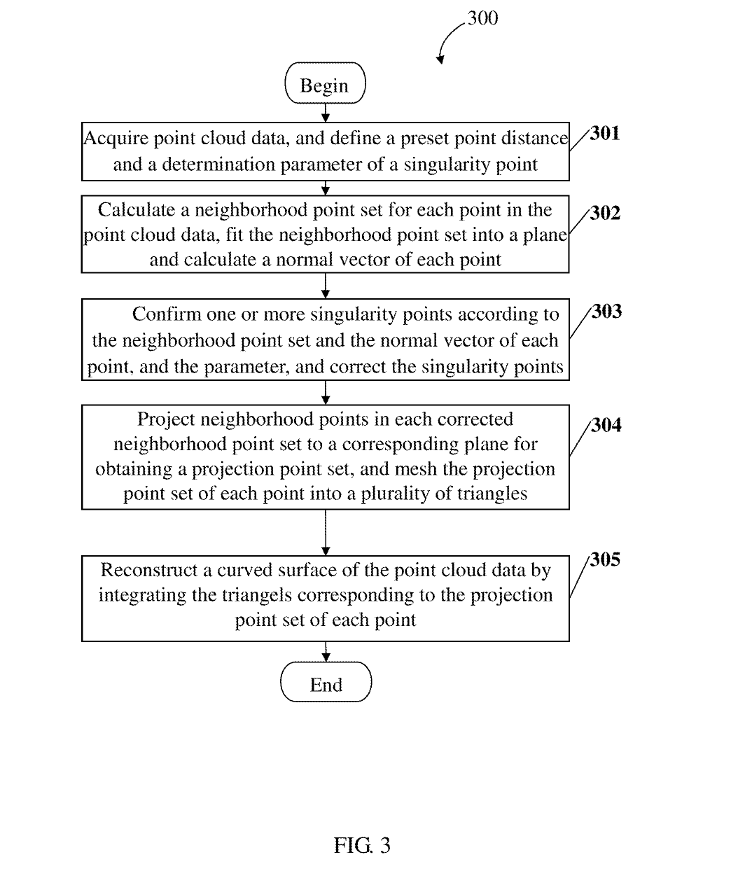

FIG. 3 is a flowchart of one embodiment of a method of reconstructing a curved surface of point cloud data using the computing device in FIG. 1. Depending on the embodiment, additional blocks can be added, others removed, and the ordering of the blocks can be changed. In the embodiment, the method 300 is performed by execution of computer-readable software program codes or instructions by at least one processor of a computing device. The method 300 is provided by way of example, as there are a variety of ways to carry out the method. The method 300 described below can be carried out using the configurations illustrated in FIG. 1 and FIG. 2, for example, and various elements of these figures are referenced in explaining method 300. Each block shown in FIG. 3 represents one or more processes, methods or subroutines, carried out in the method 300. Additionally, the illustrated order of blocks is by example only and the order of the blocks can change according to the present disclosure. The example method 300 can begin at block 301.

In block 301, the acquisition module acquires point cloud data of an object which needs to construct a curved surface from the storage system 12, and further defines parameters related to reconstructing the curved surface. In one embodiment, the point cloud data can be acquired form other point cloud scanning device (not shown in FIG. 1). The parameters includes, but is not limited to, a preset point distance and a determination parameter (referred as “C”) of a singularity point. In the embodiment, the determination parameter “C” is a constant. For example, a value of the determination parameter “C” can be set to be 0.5 or 2. The parameters can be preset according actual requirements for different objects.

In block 302, the calculation module calculates a neighborhood point set for each point in the point cloud data according to the preset point distance, fits the neighborhood point set of each point in the point cloud data to be a plane, and calculates a normal vector of the plane corresponding to each point. In one embodiment, a distance between each point and each neighborhood point in the neighborhood point set of the each point are less than or equal to the preset point distance.

In block 303, the correction module confirms one or more singularity points in the point cloud data according to the neighborhood point set of each point, the normal vector of each point, and the determination parameter, and further corrects the one or more singularity points for the neighborhood point set of each point. In one embodiment, the correction module first calculates an average distance between neighborhood points in the neighborhood point set for each point and the plane of fitted by the neighborhood point set of each point. If a distance between a point “i” and the plane is greater than a product of the determination parameter and the average distance between the neighborhood points corresponding to the point “i” and the plane corresponding to the point “i”, the correction module 102 determines that the point “i” is the singularity point. Furthermore, the correction module corrects the one or more singularity points by replacing each singularity point using a project point projected by the singularity point on a plane corresponding to the singularity point.

In block 304, the first processing module obtains a projection point set of each point by projecting corrected neighborhood points in the neighborhood point set of each point to the plane of each point, and meshes the projection point set of each point into a plurality of triangles according to a regular triangulation method. In the embodiment, the regular triangulation method is based on a Delaunay triangulation method and preset distance weight values.

In block 305, the second processing module reconstructs the curved surface of the point cloud data by integrating the plurality of triangles corresponding to the projection point set of each point. In one embodiment, the second processing module can connect triangles which have the same side with one other to obtain the curved surface.

All of the processes described above can be embodied in, and fully automated via, functional code modules executed by one or more general purpose processors such as the processor 11. The code modules can be stored in any type of non-transitory readable medium or other storage system such as the storage system 12. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computer-implemented method for reconstructing a curved surface of point cloud data of an object using a computing device, the method comprising:
acquiring the point cloud data from a storage system of the computing device, and defining a preset point distance and a determination parameter of a singularity point in the point cloud data;
calculating a neighborhood point set for each point in the point cloud data according to the preset point distance;
fitting the neighborhood point set of each point in the point cloud data to be a plane, and calculating a normal vector of the plane corresponding to each point;
confirming one or more singularity points in the point cloud data according to the neighborhood point set of each point, the determination parameter, and the normal vector corresponding to each point;
correcting the one or more singularity points for the neighborhood point set of each point;
obtaining a projection point set of each point by projecting neighborhood points in the corrected neighborhood point set of each point to the plane corresponding to each point, and meshing the projection point set of each point into a plurality of triangles; and
reconstructing the curved surface of the point cloud data by integrating the plurality of triangles corresponding to the projection point set of each point.

2. The method according to claim 1, wherein the preset point distance is more than a distance between each neighborhood point in the neighborhood point set and each point.

3. The method according to claim 1, wherein the singularity point is confirmed by:
calculating an average distance between the neighborhood points in the neighborhood point set of each point and the plane fitted by the neighborhood point set of each point; and
determining a specified point is the singularity point if a distance between the specified point and the plane corresponding the specified point is greater than a product of the determination parameter and the average distance corresponding to the specified point.

4. The method according to claim 1, wherein the singularity point is corrected by replacing each singularity point using a project point projected by the singularity point on a plane corresponding to the singularity point.

5. The method according to claim 1, wherein the curved surface is reconstructed by connecting triangles which have the same side with one another.

6. A non-transitory computer-readable storage medium storing a set of instructions, when executed by at least one processor of a computing device, cause the at least one processor to perform a method for reconstructing a curved surface of point cloud data of an object, the method comprising:
acquiring the point cloud data from a storage system of the computing device and defining a preset point distance and a determination parameter of a singularity point;
calculating a neighborhood point set for each point in the point cloud data according to the preset point distance;
fitting the neighborhood point set of each point in the point cloud data to be a plane, and calculating a normal vector of the plane corresponding to each point;
confirming one or more singularity points in point cloud data according to the neighborhood point set of each point, the determination parameter, and the normal vector corresponding to each point;
correcting the one or more singularity points for the neighborhood point set of each point;
obtaining a projection point set of each point by projecting neighborhood points in the corrected neighborhood point set of each point to the plane corresponding to each point, and meshing the projection point set of each point into a plurality of triangles; and
reconstructing the curved surface of the point cloud data by integrating the plurality of triangles corresponding to the projection point set of each point.

7. The storage medium according to claim 6, wherein the preset point distance is more than a distance between each neighborhood point in the neighborhood point set and each point.

8. The storage medium according to claim 6, wherein the singularity point is confirmed by:
calculating an average distance between the neighborhood points in the neighborhood point set of each point and the plane fitted by the neighborhood point set of each point;
determining a specified point is the singularity point if a distance between the specified point and the plane corresponding the specified point is greater than a product of the determination parameter and the average distance corresponding to the specified point.

9. The storage medium according to claim 6, wherein the singularity point is corrected by replacing each singularity point by a project point projected by the singularity point on a plane corresponding to the singularity point.

10. The storage medium according to claim 6, wherein the curved surface is reconstructed by connecting triangles which have the same side with one another.

11. A computing device, the computing device comprising:
at least one processor; and
a storage system storing one or more programs, which when executed by the at least one processor, cause the at least one processor to:
acquire point cloud data of an object from the storage system and define a preset point distance and a determination parameter of a singularity point;
calculate a neighborhood point set for each point in the point cloud data according to the preset point distance;
fit the neighborhood point set of each point in the point cloud data to be a plane, and calculating a normal vector of the plane corresponding to each point;
confirm one or more singularity points in the point cloud data according to the neighborhood point set of each point, the determination parameter, and the normal vector corresponding to each point;
correct the one or more singularity points for the neighborhood point set of each point;
obtain a projection point set of each point by projecting neighborhood points in the corrected neighborhood point set of each point to the plane corresponding to each point, and meshing the projection point set of each point into a plurality of triangles; and
reconstruct the curved surface of the point cloud data by integrating the plurality of triangles corresponding to the projection point set of each point.

12. The computing device according to claim 11, wherein the preset point distance is more than a distance between each neighborhood point in the neighborhood point set and each point.

13. The computing device according to claim 11, wherein the singularity point is confirmed by:
calculating an average distance between the neighborhood points in the neighborhood point set of each point and the plane fitted by the neighborhood point set of each point;
determining a specified point is the singularity point if a distance between the specified point and the plane corresponding the specified point is greater than a product of the determination parameter and the average distance corresponding to the specified point.

14. The computing device according to claim 11, wherein the singularity point is corrected by replacing each singularity point by a project point projected by the singularity point on a plane corresponding to the singularity point.

15. The computing device according to claim 11, wherein the curved surface is reconstructed by connecting triangles which have the same side with one another.
